(19) United States
(12) Patent Application Publication
(10) Pub. No.: US 2003/0022055 A1
(43) Pub. Date: Jan. 30, 2003

(54) Fuel cells and other products containing modified carbon products

(76) Inventor: Jameel Menashi, Lexington, MA (US)

Correspondence Address: Martha Ann Finnegan, Esq., CABOT CORPORATION, Billerica Technical Center, 157 Concord Road, Billerica, MA, 01821-7001, US

(21) Appl. No.: 09/833,202

(22) Filed: Apr. 11, 2001

(51) Int. Cl. H01M 4/96; H01M 4/94; H01M 8/10; H01M 4/88

(52) U.S. Cl. 429/44; 429/42; 429/33; 502/101

(57) ABSTRACT

Fuel cells are described and contain a gas diffusion electrode, a gas diffusion counter-electrode, an electrolyte membrane located between the electrode and counter-electrode. The electrode or counter-electrode or both contain at least one modified carbon product. The electrolyte membrane can also or alternatively contain modified carbon products as well. The modified carbon product is a carbon product having attached at least one organic group. Preferably the organic group is a proton conducting group and/or an electron conducting group. The present invention preferably permits the elimination of fluoropolymer binder in the active or catalyst layer and further preferably leads to a thinner active layer and/or a thinner electrolyte membrane. Other uses and advantages are also described.

### BACKGROITND OF THE INVENTION

The present invention relates to fuel cells and gas diffusion electrodes which can be used in a variety of applications. The present invention further relates to methods of preparing the fuel cells and other products. The present invention further relates to materials particularly suitable in the manufacture of fuel cells and gas diffusion electrodes and other electrodes.

A gas diffusion electrode (GDE) typically contains a hydrophobic polymer in contact with a high surface area electrically conductive or semiconductive material which supports the finely dispersed catalyst particles. The hydrophobic polymer is usually PTFE (polytetrafluoroethylene), the support material is usually carbon, and the catalyst is usually a metal, such as platinum. The polymer-catalyst-support layer is held by a carbon cloth or a carbon paper. The side of the electrode which contains the catalyst layer is referred to as the “catalytic” side and the opposite side is referred to as the “gas” or gas-permeable side

A GDE is used in electrochemical processes for bringing gaseous reactants to the reaction sites in contact with an electrolyte. Such an electrochemical process is typically used in a fuel cell for generating electricity. A GDE can be used in an alkaline, phosphoric acid, and proton exchange membrane (PEM) electrolyte fuel cell, also referred to as a solid polymer electrolyte fuel cell (SPFC). The former two electrolytes—alkaline and phosphoric acid—being liquid, can easily bathe the catalyst (or reaction sites) and make good contact with the catalyst for optimum fuel cell performance. A three dimensional reaction zone on an electrode in contact with the electrolyte is not created easily since the PEM electrolyte is a solid. The result is that the efficiency of utilization of the catalyst in a fuel cell reaction involving a PEM electrolyte is low, about 10-20%. Attempts have been made to address this problem by (a) impregnating a small amount of electrolyte solution into the electrode structure, drying the electrolyte and finally pressing the impregnated electrodes against the PEM electrolyte, (b) using a relatively greater proportion of platinum in the platinum/carbon mixture that constitutes the porous electrode, (c) sputtering a thin layer of platinum on top of the porous electrode and, in some limited cases, (d) depositing a layer of platinum on top of the already catalyzed electrode.

Accordingly, fuel cells and gas diffusion electrodes overcoming one or more of the above-described disadvantages are desirable. In addition, fuel cells and gas diffusion electrodes which are less expensive to manufacture and/or operate more efficiently would be preferred in the industry.

### SUMMARY OF THE PRESENT INVENTION

A feature of the present invention is to provide fuel cells having beneficial properties.

Another feature of the present invention is to provide gas diffusion electrodes which can be used in a variety of devices and applications which have improved properties.

A further feature of the present invention is to provide fuel cells that are preferably less expensive to manufacture and/or are more efficient to operate.

A further feature of the present invention is to provide fuel cells having reduced cross over.

An additional feature of the present invention is to provide inner membranes used in fuel cells and other devices.

Another feature of the present invention is to provide an active layer in a gas diffusion electrode which is thinner and/or has improved catalyst accessibility.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a fuel cell containing a gas diffusion electrode, a gas diffusion counter-electrode, an electrolyte membrane located between the electrode and counter-electrode, wherein the electrode or the counter-electrode or both contain at least one modified carbon product. The electrolyte membrane can contain modified carbon products as well which can be the same or different from any modified carbon product contained in one or both electrodes. The modified carbon product is a carbon product having attached at least one organic group.

The present invention further relates to an electrolyte membrane containing at least one modified carbon product, wherein the modified carbon product contains at least one carbon product having attached at least one organic group.

The present invention also relates to a gas diffusion electrode containing a blocking layer and an active layer, wherein the active layer contains at least one modified carbon product. The active layer is preferably less than about 10 microns thick.

The present invention further relates to a catalytic material containing a modified carbon product having attached at least one catalytic material.

The present invention also relates to method of preparing a catalytic material which involves depositing catalyst on a modified carbon product.

The present invention further relates to methods of making thinner electrolyte membranes with the use of modified carbon products and further relates to methods of reducing cross over with the use of the modified carbon products.

Furthermore, the present invention relates to a method of improving catalyst accessibility by using a modified carbon product in the active layer and more preferably using a catalytic material which contains a modified carbon product having attached at least one organic group and catalytic material.

It is to be understood that both the foregoing general description and the following detailed description are exemplary and explanatory only and are intended to provide a further explanation of the present invention, as claimed.

The accompanying drawings, which are incorporated in and constitute a part of this application illustrate several embodiments of the present invention and together with the description, serve to explain the principles of the present invention.

### BRIEF DFSCRIPTION OF THE DRAWINGS

FIG. 1 is a graph showing H₂/O₂ feed comparisons for several embodiments of the present invention.

FIG. 2 is a graph showing H₂/air feed comparison for several embodiments of the present invention.

FIG. 3 is a graph providing various data of a CO oxidation curve.

FIG. 4 illustrates a fuel cell which can be used in the present invention.

### DETAILED DESCRIPTION OF THE PRESENT INVENTION

The present invention relates to the use of one or more types of modified carbon products in various components of a fuel cell. In the present invention, modified carbon products can be used in the gas diffusion electrode, the gas diffusion counter-electrode, and/or the electrolyte membrane located between the electrode and counter-electrode. One or all of the components can contain the modified carbon product and the modified carbon product can be different for each component of the fuel cell.

In an embodiment of the present invention, the catalyst layer or active layer of a gas diffusion electrode can primarily contain one or more modified carbon products with or without at least one binder. Preferably, the amount of binder which can be a Nafion type fluoropolymer can be substantially reduced and more preferably eliminated entirely by using a modified carbon product. Preferably, the modified carbon product has attached at least one organic group wherein the modified carbon product serves as an electron conductor and/or also as a proton conductor. Thus, a modified carbon product used in the catalyst layer can serve the function of the fluoro-binder, such as Nafion. With the use of modified carbon products in the catalyst layer, improved catalyst activity is preferably accomplished which can be achieved for a number of reasons such as enhancement in the catalyst effectiveness and enhancement in mass transport. Since the catalyst particles that are present in the catalyst layer should be as close in proximity to the proton conducting groups for excellent catalyst utilization, the use of modified carbon products which have organic groups acting as electron conductors and proton conductors permits the catalyst particles to be in close proximity to these proton conducting groups which is not possible when a binder such as Nafion is used as the proton conductor.

The catalyst layer using the modified carbon products can be formed in a number of ways. The modified carbon products can be used in place of conventional carbon black that is present in catalyst layers and thus can be formed in the same manner. Alternatively or in combination, the carbon support used as the catalyst layer can be formed of modified carbon products and then the deposition of the catalyst particles (e.g., metal catalyst, such as Pt) such as by noble metal deposition can be directly on the carbon support. This type of method ensures the close proximity of the catalyst particles to the modified carbon products.

In more detail, when a binder such as Nafion binder is used in the active layer, there is a trade-off between the benefits of improved proton conduction and reduced mass transfer of gas to the catalyst. The binder increases mass transfer resistance by being deposited on the metal catalyst and in the pores of the active layer. The amount of binder employed can be reduced or, more preferably, completely eliminated by using a catalyzed support having modified carbon products present. As an example, if the modified carbon product is a carbon black having attached —C₆H₄SO₃H groups, the equivalent weight (EW) of the —SO₃H groups in a perfluorosulfonic acid, such as Nafion, is about 1100 whereas the molecular weight of the attached —C₆H₄SO₃H group is 157. Accordingly, a treatment weight that is approximately 1/7 that of the weight of the Nafion binder can be used to provide the same number of proton conducting groups. Thus, the present invention permits less material present in the catalyst layer and by reducing the amount of material present in the catalyst layer, the mass transfer should be greatly improved which permits excellent catalyst utilization.

Furthermore, with respect to the catalyst layer, preferably the catalyst layer is very thin such as 10 microns or less thick. If the catalyst layer cannot be made thin, porosity in the active layer is generally needed to aid transport of the reactive gas to the catalyst. In fact, typically humidified gases are used in fuel cells to keep the electrolyte membrane and the fluoronated binder in the catalyst layer hydrated. Typically, hydrophobic pores are introduced into the active layer to avoid pore flooding by the use of fluoronated particulates such a PTFE. However, while the use of PTFE particulates, for instance, may solve one problem they also create another problem by blocking access to many of the catalyst sites. Accordingly, with the present invention, catalyst accessibility can be substantially increased by using either a hydrophobicly treated carbon product or by using a carbon product which has attached hydrophobic groups as well as hydrophilic groups. By using the modified carbon products in the catalyst layer, the thickness of the catalyst layer can be greatly reduced since the need for binder is reduced or completely eliminated and fluoronated materials can be avoided due to the solutions offered by the modified carbon products and the particular selection of organic groups attached onto the carbon products. Since surface functionalization can be used to make the carbon products hydrophobic at the primary particle level at modest treatment levels, a smaller volume of a hydrophobicly treated carbon product is used to introduce the same level of hydrophobic porosity compared to a conventional carbon black made hydrophobic with PTFE. Accordingly, the present invention permits a thinner active layer and hence improved mass transport of the reactive gases to the catalytic sites. With the present invention, preferably the catalyst layer has a film thickness of less than 10 microns and more preferably less than about 5 microns and even more preferably a thickness of from about 2 microns to about 5 microns.

In the present invention, the carbon products used to form the modified carbon product can be any type of carbon product and preferably those associated with gas diffusion electrodes. Preferably, the carbon products and more preferably carbon black are relatively micropore-free. Although acetylene blacks and carbon blacks with comparably small surface areas are micropore-free, their low surface areas make them less suitable for use with conventional methods of supported catalyst formation due to larger platinum crystallites. Accordingly, preferred carbon products, especially carbon blacks, are those having large surface areas wherein the ratio of micropore-free surface area to total surface area is as large as possible.

In an additional embodiment of the present invention, the catalyst layer which contains the modified carbon product can undergo an ion exchange reaction with the metal catalyst such as Pt. The cationic metal catalyst complex can be attached or absorbed onto the modified carbon products. Organic groups on the modified carbon products can be strongly acidic and thus function as excellent proton conductors in a fuel cell. Having the metal catalyst in very close proximity to the organic groups makes it quite possible to form an active layer with a catalyst, proton conductor, and electron conductor in extremely close proximity to each other which permits excellent catalyst utilization. Furthermore, the particular organic groups on the carbon product can be regenerated. Thus, the functionalized carbon product can be subjected to several cycles of ion exchange, reduction, and drying to achieve any desired loading of noble metal regardless of the carbon product surface area. Preferably, the carbon product surface area is high in order to achieve a higher attachment level which results in smaller noble metal crystallites. Furthermore, with the attachment of organic groups on the carbon product, the ratio of micropore-free surface area to total surface area is significantly increased which in turn reduces catalyst lost in micropores.

As an option, the catalyzed treated carbon products can be made partially or fully hydrophobic by contacting the carbon product with an aqueous solution of a fluoronated material (e.g. a fluoronated cationic surfactant such as ZONYL FSD from DuPont). The use of a fluoronated cationic surfactant leads to the further modification of the organic group onto the carbon product. For instance, when the organic group is —C₆H₄SO₃H, the following reaction preferably occurs: —C₆H₄SO₃H+Cl⁻N⁺(CH₃)₃CH₂CH₂(CF₂CF₂)ₙCF₃→—C₆H₄sO₃N(CH₃)₃CH₂CH₂(CF₂CF₂)ₙCF₃+HCl

In addition, in forming the catalyst layer, the use of modified carbon products especially with hydrophilic organic groups present, permits the dispersibility of the modified carbon products and aqueous solutions such as water or methanol and permits the forming of a thin proton conducting catalyst layer which can be formed directly, for instance, on the membrane. Thus, a uniform and thin catalyst layer can be formed with the present invention which is different from conventional catalyzed dispersions containing PFSA which cannot be applied in such a manner because the solvent, such as isopropanol, added to keep the PFSA in solution distorts the membrane. Thus, the present invention permits the formation of catalyst layers directly on the fuel cell membrane.

In addition, with respect to the membrane, in an embodiment of the present invention, the membrane (e.g., solid polymer electrolyte membrane) can contain modified carbon products which avoids loss in ionic conductivity. As mentioned previously, the equivalent weight of fluoropolymers such as Nafion binder is about 1100 while the equivalent weight of certain organic groups on a carbon product can equal or be even smaller than that in Nafion binder. For example, attachment of 4 micromols/m² of —C₆H₄SO₃H to carbon blacks with t-areas of 300 and 600 m²/g provided equivalent weights of 1000 and 574 respectively. Thus, the incorporation of modified carbon products, such as carbon black with a high level of attached organic groups such as —C₆H₄SO₃H onto the membrane can reduce the extent of crossover without adversely effecting proton conductivity. Furthermore, the reduced crossover preferably permits the use of thinner membranes resulting in diminished ohmic losses in fuel cells. Preferably, the amount of modified carbon product present in the membrane does not exceed the membrane's percolation threshold. Thus, preferably the largest possible modified carbon product loading can be achieved with the use of functionalized carbon products such as modified carbon blacks with low structural levels. By using the modified carbon products of the present invention, reductions in the thickness of the membrane can be achieved without adversely effecting crossover. For instance, a reduction of at least 5% in the thickness of the membrane can be achieved and more preferably at least 10% reduction and even more preferably at least a 15% reduction in the thickness of the membrane can be achieved without adversely effecting crossover.

In forming the blocking layer or the active layer, the modified carbon product can be combined with at least one binder to form a paste which will then be used to form a layer. The paste which forms the layer is typically put on a conductive substrate such as a nickel substrate or other conductive metal substrate or material. While the blocking layer and/or the active layer can contain any type of modified carbon product, when a modified carbon product forms the blocking layer, it is preferred that the modified carbon product be hydrophobic in nature. Thus, it is preferred that the modified carbon product comprise at least one carbon product having attached at least one organic group which is hydrophobic in nature. In other words, it is preferred that a hydrophobic organic group be attached to the carbon product to form the modified carbon product.

Preferably, the organic groups attached onto the carbon product are proton conducting groups and/or electron conducting groups.

Examples of hydrophobic organic groups which are attached to the carbon product include, but are not limited to, 1) saturated and unsaturated alkyl groups, aryl groups, ethers, poly ethers, 2) fluorinated saturated and un-saturated alkyl groups, aryl groups, ethers, poly ethers; 3) poly or oligo fluorinated compounds, and the like.

Preferably, the organic group which is attached to the carbon product to promote the hydrophobic properties has the general formula —A—R, wherein A is an aromatic group and/or an alkyl group and R represents fluorine and/or a fluorine containing substitutent. The alkyl group is preferably a C₁-C₂₀ alkyl group and more preferably is a C₁-C₁₂ alkyl group. The aromatic group can include multiple rings. Also, more than one R group can be located on the aromatic group and each of these R groups can be the same or different. More preferably, the hydrophobic group is Ar —CF₃ where —CF₃ is preferably in the meta position.

With respect to the active layer, as stated earlier, preferably the active layer contains a modified carbon product which promotes hydrophilic and hydrophobic characteristics. In order to promote the hydrophilic characteristics of the carbon product which has a tendency to be naturally hydrophobic, the carbon product preferably has attached at least one type of hydrophilic organic group which can be an aromatic or alkyl group 7substituted with an ionic group; an ionizable group; a non-ionic hydrophilic group; or a mixture thereof. Preferably, the hydrophilic type organic group is a sulfophenyl group or a carboxyphenyl group, or salts thereof. Examples of the ionic or ionizable group include, but are not limited to, sulfonilic acid groups and salts thereof. Alternatively, the carbon product can have attached at least one type of hydrophobic organic group and can be used in forming the active layer.

In more detail, ionizable functional groups forming anions include, for example, acidic groups or salts of acidic groups. The organic groups, therefore, include groups derived from organic acids. Preferably, when the organic group contains an ionizable group forming an anion, such an organic group has a) an aromatic group or a C₁-C₁₂ alkyl group and b) at least one acidic group having a pKa of less than 11, or at least one salt of an acidic group having a pKa of less than 11, or a mixture of at least one acidic group having a pKa of less than 11 and at least one salt of an acidic group having a pKa of less than 11. The pKa of the acidic group refers to the pKa of the organic group as a whole, not just the acidic substituent. More preferably, the pKa is less than 10 and most preferably less than 9. Preferably, the aromatic group or the alkyl group of the organic group is directly attached to the carbon product. The aromatic group may be further substituted or unsubstituted, for example, with alkyl groups. The C₁-C₁₂ alkyl group may be branched or unbranched and is preferably ethyl. More preferably, the organic group is a phenyl or a naphthyl group and the acidic group is a sulfonic acid group, a sulfinic acid group, a phosphonic acid group, or a carboxylic acid group. Examples include —COOH, —SO₃H, —PO₃H₂, —SO₂NH₂, —SO₂NHCOR, and their salts, for example —COONa, —COOK, —COO⁻NR₄⁺, —SO₃Na, —HPO₃Na, —SO₃⁻NR₄⁺, and PO₃Na₂, where R is an alkyl or phenyl group. Particularly preferred ionizable substituents are —COOH and —SO₃H and their sodium, potassium, lithium salts. It is understood these cationic counter ions can be exchanged to other ions through an ion-exchange process.

Most preferably, the organic group is a substituted or unsubstituted sulfophenyl group or a salt thereof; a substituted or unsubstituted (polysulfo)phenyl group or a salt thereof; a substituted or unsubstituted sulfonaphthyl group or a salt thereof; or a substituted or unsubstituted (polysulfo)naphthyl group or a salt thereof. A preferred substituted sulfophenyl group is hydroxysulfophenyl group or a salt thereof. Specific organic groups having an ionizable functional group forming an anion are p-sulfophenyl, 4-hydroxy-3-sulfophenyl, and 2-sulfoethyl. More preferred examples include p-C₆H₄SO₃⁻Na⁺ and C₆H₄CO₂⁺Na⁺.

Amines represent examples of ionizable functional groups that form cationic groups and can be attached to the same organic groups as discussed above for the ionizable groups which form anions. For example, amines may be protonated to form ammonium groups in acidic media. Preferably, an organic group having an amine substituent has a pKb of less than 5. Quaternary ammonium groups (—NR₃⁺), quaternary phosphonium groups (—PR₃⁺), and sulfonium groups (—SR₂⁺) also represent examples of cationic groups and can be attached to the same organic groups as discussed above for the ionizable groups which form anions. Preferably, the organic group contains an aromatic group such as a phenyl or a naphthyl group and a quaternary ammonium, a quaternary phosphonium group, or a sulfonium group. The aromatic group is preferably directly attached to the carbon product. Quaternized cyclic amines and quaternized aromatic amines can also be used as the organic group. Thus, N-substituted pyridinium compounds, such as N-methyl-pyridyl, can be used in this regard. Examples of organic groups include, but are not limtied to, 3-C₅H₄N(C₂H₅)⁺, C₆H₄NC₅H₅⁺, C₆H₄COCH₂N(CH₃)₃⁺, C₆H₄COCH₂(NC₅H₅)⁺, 3-C₅H₄N(CH₃)⁺, and C₆H₄CH₂N(CH₃)₃⁺. Counter ions to those groups include, but are not limited to, Cl⁻, NO₃⁻, OH⁻, and CH₃COO⁻. It is understood that these anionic counter ions can be exchanged to other ions through an ion-exchange process.

As stated earlier, non-ionic hydrophilic groups can be used. Examples of the non-ionic hydrophilic groups include, but are not limited to, groups having no apparent ionic change and can not be transformed to have an ionic charge, such as polymers/oligomers of the ethylene oxide, propylene oxide, other alkylene oxides, glycols, alcohols, and the like.

As part of the present invention, it is preferred that the amount of hydrophilic organic groups attached to the carbon product is controlled in order to avoid making the modified carbon product overly hydrophilic. In particular, as a preferred embodiment of the preferred invention, the treatment level, which is expressed in terms of μmol/m² of carbon, of the hydrophilic organic group on the carbon product is from about 0.04 μmol/m² to about 6 μmol/m², more preferably from about 0.1 μmol/m² to about 2 μmol/m², and most preferably from about 0.2 μmol/m² to about 0.8 μmol/m².

In a more preferred embodiment of the present invention, the carbon product which has attached at least one hydrophilic organic group, also has attached at least one hydrophobic organic group as well to better promote a hydrophobic/hydrophilic balance in the active layer. The hydrophobic organic groups can be the same as described above. For purposes of this preferred embodiment of the present invention, the treatment level of the hydrophobic organic group on the modified carbon product is preferably from about 0.04 μmol/m² to about 6 μmol/m², more preferably from about 0.1 μmol/m² to about 4 μmol/m², and most preferably from about 0.5 μmol/m² to about 3 μmol/m².

Alternatively, instead of a dual or multi-treated modified carbon product as described above in the preferred embodiment, two or more different types of modified carbon products can be used, in particular, one modified carbon product can be a carbon product having attached at least one hydrophilic organic group and a second type of modified carbon product can be used which is a carbon product having attached at least one hydrophobic organic group. Then, in this embodiment, a mixture of the two different types of modified carbon products can be used to form the active layer along with the optional presence of a binder.

Any carbon products that are used in diffusion electrodes can be used in the present invention. Examples of such carbon products include, but are not limited to, graphite, carbon black, vitreous carbon, activated charcoal, carbon fiber, activated carbon, and carbon aerogel. Catalyzed carbon products that are used in diffusion electrodes can also be used in the present invention, wherein surface modification can be performed either before or after the catalization step. Finely divided forms of the above are preferred. Further, mixtures of different carbon products can be used. Preferably, the carbon product used is capable of reacting with a diazonium salt to form the above-mentioned carbon products. The carbon may be of the crystalline or amorphous type. In addition, mixtures of different types of modified carbon products with or without unmodified carbon products can also be used in the present invention as one embodiment.

Examples of the organic groups which are attached onto the carbon product to form a modified carbon product and methods to attach organic groups are described in the following U.S. patents and publications which are all incorporated in their entirety by reference herein: U.S. Pat. Nos. 5,851,280; 5,837,045; 5,803,959; 5,672,198; 5,571,311; 5,630,868; 5,707,432; 5,803,959; 5,554,739; 5,689,016; 5,713,988; WO 96/18688; WO 97/47697; and WO 97/47699.

Besides the presence of the modified carbon product in one or more components of the electrode described above, conventional ingredients used in electrodes can also be present in the electrodes of the present invention. For instance, fluorine containing compounds typically used in diffusion electrodes can also be used in the present invention such as polytetrafluoroethylene in the blocking layer. Likewise, in the active layer, a perfluoric sulphonic acid polymer sold under the trade name Nafion® can be used with the modified carbon products. However, one preferred advantage of the present invention is the ability to reduce such fluorine containing compounds in the blocking layer and/or active layer. The proper choice of organic groups attached onto the carbon product to form the modified carbon product can lead to a decrease if not an elimination of fluorine containing compounds which in the past have been used in conjunction with carbon black in order to promote the hydrophilic and/or hydrophobic properties discussed above. The reduction or elimination of such fluorine containing compounds can greatly reduce the cost of the electrodes and thus the present invention provides a very economical electrode. Preferably, for purposes of the present invention, the amount of the reduction of a hydrophobic fluorine containing compound in the blocking layer is from about 10 to about 100% by weight, more preferably from about 40 to about 100% by weight. Further, with respect to the active layer, preferably the amount of reduction of the fluorine containing compound is from about 10 to about 100% by weight, more preferably from about 60 to about 100% by weight.

Catalyst utilization has been rather poor in conventional fuel cells because of the nature of the interface. It was found that, in conventional electrodes, a large part of the catalyst is not effective. The electrochemical reaction takes place only in those areas where catalyst is accessible both to the reactant gas and the electrolyte. PTFE makes the catalytic layer partly impermeable to the electrolyte so that the catalyst efficiency is lowered, also resulting in the decrease of the electrode performance. On the other hand, a large amount of PTFE is required in the gas diffusion layer to prevent the electrolyte diffusivity over a long period of time. This results in the reduction of the gas mass transport efficiency due to the blocking effect of PTFE inside the fine porous structure.

Since the modified carbon products of the present invention promote hydrophobic and/or hydrophilic properties on a molecular scale, there is no random wetting of the carbon products and a very even distribution of the wetting characteristics exists throughout the active layer for instance. Thus, the unwanted excessive wetting of the carbon products can be avoided throughout the entire active layer which then leads to a long term operation thus promoting the extension of the service life of the electrode. Further, with respect to the blocking layer, with a modified carbon product having attached hydrophobic organic groups, the blocking layer quite effectively blocks any electrolyte and permits the greatest amount of air diffusion.

The fuel cells and the components of the fuel cell, including the electrodes described in U.S. Pat. Nos. 5,783,325; 5,521,020; 5,733,430; 5,561,000; and 5,116,592 can be used in the present invention and these patents are incorporated in their entirety by reference herein. These patents provide examples of catalyst particles, fluoropolymers, various layers of electrodes and the like which can be used herein or can be further modified as described here with the modified carbon product or the modified carbon product associated with the catalyst.

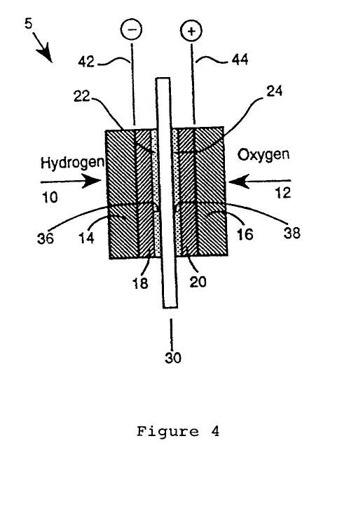

FIG. 4 provides one example of a fuel cell 5 wherein electrodes 18 and 20 are shown, and wherein 36 and 38 depict catalyst layers. Anode connection 42 and cathode connection 44 are shown and are connected to an external circuit (not shown). 22 and 24 reflect optional electrolyte deposits that are in contact with the solid membrane 30. The fuel cell includes gaseous reactants, such as a fuel source 10 and an oxidizer source 12, wherein the gases 10 and 12 diffuse through anode backing layer 14 and cathode baking layer 16, respectively, to porous electrodes forming an oxidizing electrode or anode 18 and a reducing electrode or cathode 20. Further details of this conventional fuel cell are set forth in U.S. Pat. No. 5,521,020 and the other patents referenced above.

In addition, the use of modified carbon products can also apply to direct methanol fuel cells with the obtaining of similar benefits as described above. Furthermore, the use of modified carbon products in direct methanol fuel cells has the ability to reduce methanol crossover.

Besides air electrodes, the present invention relates to gas diffusion electrodes in general, wherein the active layer and/or blocking layer that may be present in gas-diffusion electrodes can include modified carbon products as described above and serve the same function as the modified carbon products incorporated in the active layer and/or blocking layer of the electrode. Gas-diffusion electrodes, which include air-diffusion electrodes, prepared with modified carbon material have broad applications. One example of a gas diffusion electrode application would be a phosphoric acid type fuel-cell using a pair of gas diffusion electrodes. Such gas diffusion electrodes are described, for instance, in U.S. Pat. Nos. 5,846,670; 5,232,561; and 5,116,592, and all incorporated in their entirety by reference herein. Other applications are described in EP 435835, (Electro-plating); U.S. Pat. Nos. 5,783,325; 5,561,000; 5,521,020 (Solid polymer electrolyte fuel cells); U.S. Pat. No. 5,733,430 (Sodium chloride electorlysis); U.S. Pat. No. 5,531,883 (Ozone generation cells); U.S. Pat. No. 5,302,274 (Gas Sensor); U.S. Pat. No. 4,892,637 (Alkali chloride electrolyzers, air cells, and fuel cells); EP 327 018 A2 (Biosensors); A. Kaishera et al., Sens. Actuators, 1995, 1327 ((1-3) (Biosensors), all are incorporated herein in their entirety by reference.

The present invention can be used in a variety of gas diffusion electrodes. For instance, but without limiting the present invention, the present invention can be used in large scale industrial applications, such as chemical production. Examples of such industrial applications include, but are not limited to, chloro-alkali production (e.g., the production of sodium hydroxide also known as salt splitting and chlorine production); hydrogen peroxide production; and the like. The present invention can also be used, as discussed above, in fuel cells, metal/air batteries, electro-platting (e.g., using hydrogen gas); ozone production, carbon dioxide decomposition; sensors for such chemicals as ozone, oxygen, nitrogen dioxide, and the like; enzyme/gas diffusion electrodes (e.g., biosensors); and the like. Each of these applications can incorporate the modified carbon material of the present invention in the electrode to obtain the benefits discussed above and one skilled in the art in view of the disclosure set forth in this present invention can apply this present invention to these various applications and therefore are considered part of the present application.

The following examples further illustrate aspects of the present invention but do not limit the present invention.

### EXAMPLES

Five membrane electrode assemblies (MEA's) were constucted. The reagents used were Pt black and 20 weight % Pt on VULCAN XC 72 carbon black (both from Alfa Aesar), Teflon PTFE 30 dispersion (DuPont) containing 60 weight % PTFE, hydrophobic Toray paper (Toray), Nafion 117 membrane (DuPont), Nafion solution, 5 weight % (Electrochem, Inc.) and Kynar 721 polyvinylidene fluoride powder (AtoFina). All MEA's were fabricated with a Nafion 117 membrane and an anode that consisted of 4.0 mg Pt 2 black/cm². Four MEA's were constructed using a standard procedure wherein the supported catalyst was bonded with PTFE. In these cases, a dispersion consisting of 90 parts of the supported Pt catalyst and 10 parts PTFE was mixed by sonification, flocculated by acidification to pH 3, and dried at 105° C. The powder was then deposited on the hydrophobic Toray paper to form a catalyst layer containing 0.5 mg Pt/cm². The catalyst layer was heated at 360° C. for 30 minutes to sinter the PTFE and bond the catalyst to itself and the paper. In the case of the fifth MEA, the supported catalyst was treated so as to attach —C₆H₄SO₃H to the carbon surface. Since the attached groups undergo thermal decomposition at elevated temperatures, the fifth MEA was bonded with Kynar 721. It should be noted that the onset for decomposition for the product with H⁺ as the counterion is about 120 to 130° C. and that when Na⁺ is the counterion is about 160 to 170° C. The four “standard” MEA's were fabricated as follows:

MEA I—the catalyst layer (backed by the hydrophobic Toray paper) was hot pressed onto a hydrated Nafion 117 membrane at 177° C. at a pressure of 2.4 to 2.8 MPa for 10 minutes. This MEA contains no SO₃H groups.

MEA II—the 5% Nafion solution was diluted with isopropanol and sprayed onto the 2 catalyst layer to achieve a 0.5 mg Nafion/cm² loading. The catalyst was then dried at 90 to 100° C. and then bonded to the membrane using the same procedure as for MEA I. The 2 Nafion solution (EW=1100) introduced 0.45 μmoles/cm of SO₃H groups.

MEA III—the PTFE bonded catalyst layer was treated in an aqueous solution to attach —C₆H₄SO₃Na groups to the carbon support. The catalyst layer/Toray paper combination (91 cm², weighing 1.3236 g and containing about 180 mg of the carbon support) was placed, catalyst face down, in a tray containing 1500 cc of water and 50 g sulfanilic acid maintained at 70° C. The solution was circulated by means of a peristaltic pump. To the solution 20 g of sodium nitrite dissolved in 200 ml of water was added over 30 minutes. Circulation of the solution was continued for another 2 hours. Thereafter, the solution was allowed to cool, the structure removed, washed with water, methanol, and finally rinsed with water and dried. The resulting structure weighed 1.3257 g. The weight gain, 2.1 mg, was small and indicated that no more than 0.13 μmoles/cm²—C₆H₄SO₃Na were attached. The structure was bonded to the membrane using the same procedure as for MEA I.

MEA IV—the PTFE bonded catalyst layer was treated in an aqueous solution containing 9 volume % isopropanol (IPA) to attach —C₆H₄SO₃Na groups to the carbon support. The isopropanol was added to aid wetting of the catalyst layer. The catalyst layer/Toray paper combination (about 50 cm² area, weighing 0.6508 g) was placed, catalyst face down, in a tray containing 1500 cc of water, 150 cc of isoproponal, and 10 g sulfanilic acid maintained at 70° C. The solution was circulated by means of a peristaltic pump. To the solution 4.2 g of sodium nitrite dissolved in 100 ml of water was added over 30 minutes. Circulation of the solution was continued for another 2 hours. Thereafter, the solution was allowed to cool. The resulting structure was washed with isopropanol followed by methanol and water and finally dried at 75° C. for two hours. The structure weighed 0.6524 g, indicating that the treatment introduced about 0.2 μmoles/cm of —C₆H₄SO₃Na groups. Since the catalyst layer in the structure appeared more pitted after treatment, some loss of catalyst had occurred. Thus, it is likely that the actual amount attached exceeded the Figure of 0.2 μmoles/cm². The dried structure was soaked in 1 M HCL solution (to replace the Na⁺ counterion with H⁺), soaked in water, rinsed, dried, and then bonded to the membrane using the same procedure as for MEA 1.

MEA V—5 g of supported catalyst and 1.3 g of sulfanilic acid in 45 ml of water were stirred and heated to 65° C. Sodium nitrite, 0.52 g, in the form of a 20 weight % aqueous solution was added to it dropwise over 30 minutes. The reaction mixture was stirred for an additional 1.5 hours. The mixture was cooled and then transferred to a dialysis bag (cellulose membrane from Sigma Chemicals with a 12 k molecular weight cut off). The reaction mixture was dialyzed four times with 3000 g aliquots of deionized water, with a change to fresh water every 10 hours. The dialyzed product was then passed through a bed of Dowex MSC-1 macroporous ion (cation) exchange resin (Aldrich). The resin had been previously converted into it H⁺ form by first contacting with excess 1 M sulfuric acid and then washing it free of sulfate ions. After ion exchange, the dispersion was dried in a vacuum oven at 65° C. Sulfur and sodium analysis indicated that the treated product contained 0.60 mmoles/g of attached —C₆H₄SO₃⁻ groups with about 94% of them having H⁺ as their counterion.

The treated catalyst was dispersed in water and reconverted to its Na⁺ by addition of NaOH to a pH of 8. The resulting dispersion was filtered and dried and mixed with 25 weight % Kynar 721 powder. The resulting mixture was deposited on the hydrophobic Toray paper and the heated at 170° C. for 30 minutes to bond the catalyst layer. Thereafter, the structure was soaked in sulfuric acid (to replace the Na⁺ with H⁺) soaked and washed with water, dried, and then bonded to the membrane using the same procedure as for MEA I. The catalyst layer contained 0.45 mg/cm² of Pt and 1.1 μmoles/cm² of —C₆H₄SO₃H groups.

Fuel Cell Performance

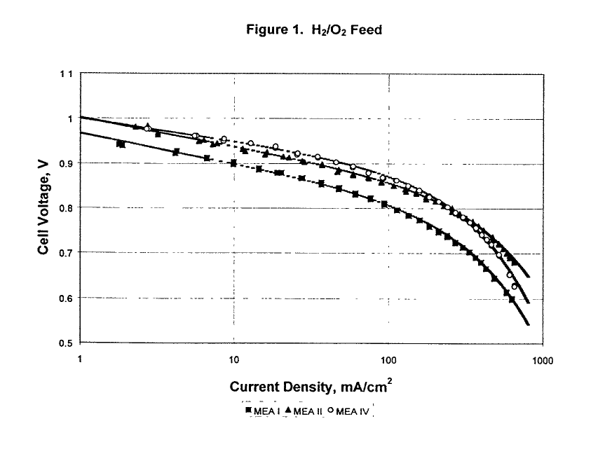

The utility of the MEA's in fuel cell applications was investigated. The MEA's (46.4 cm²) were tested at 82° C. with humidified gases at 0.2 MPa gauge pressure. Hydrogen was the fuel. Oxygen and air were employed as the cathode feeds. Stoichiometric excesses were 33% for oxygen and 2.6 fold for air. The MEA's were conditioned for about 30 minutes at the operating temperature at 430 mA/cm². After an initial polarization, the cells were operated for a further six hours using H₂/air as the gas feeds. Thereafter, the polarization curves with oxygen and air as the cathode feeds were obtained. For clarity, only those obtained for MEA I, MEA II and MEA IV with oxygen are depicted in FIG. 1. The curves were obtained by fitting the experimental points to the relationship

V=E₁—b(logi)—Ri (1)

where V is the cell voltage, E₁ is the voltage intercept at 1 mA/cm², b is the Tafel slope and R is the resistance. The data for all MEA's were well represented by Equation 1. The experimental points about the fitted curves for MEA I, II and IV are shown in the figure.

The performance of MEA I, having no proton conducting groups (i.e., no —SO₃H groups) is poor at all current densities. The conventional procedure of addition of Nafion, as shown by the curve for MEA II, results in a substantial enhancement in performance. As shown by the data for MEA IV, attachment of —C₆H₄SO₃H groups (>0.2 mmoles/cm²) to the carbon support yields a polarization curve that is essentially identical with that obtained for MEA II containing Nafion as the proton conductor. Accordingly, the present data confirms the view that the attached —C₆H₄SO₃H groups function as proton conductors.

The values of E₁, b, and R obtained by the regression analyses are summarized in Table 1. The resistance values found by impedance spectroscopy at 1000 Hz, providing a measure of the electronic and ionic resistances, are also included in the table. The results show that MEA II and IV have smaller Tafel slopes and large E₁ values than MEA I, accounting for their better performances. In the case of MEA III the regression analysis gives a large Tafel slope as well as a relatively large R value, accounting for its poor performance at the higher current densities. Although no reason can be provided to account for its large Tafel slope, it is likely that the relatively poor performance of MEA III can be attributed to the presence of an insufficient number of attached —C₆H₄SO₃H groups. The superior performance of MEA IV, having a larger level of attached —C₆H₄SO₃H groups is consistent with this view.

TABLE I
Values Derived By Regression Analysis and Impedance Spectroscopy

| | Regression Analysis | | | *IS |
|---|---|---|---|---|
| | | | R, | R, |
| | E₁ | b | V/100 | V/100A/ |
| MEA | Volts | mV/dec | A/cm² | cm² |
| I - No Treatment (0 μmoles/cm² | 0.967 | 0.066 | 29.4 | 37 |
| SO₃H) | | | | |
| II - Nafion (0.45 μmole/cm² SO₃H) | 1.001 | 0.062 | 21.5 | 17 |
| III - Aqueous Treatment (˜0.1 | 1.005 | 0.080 | 35.4 | 25 |
| μmoles/cm² SO₃H) | 0.999 | 0.048 | 38.9 | 30 |
| IV - Aqueous/IPA Treatment (>0.2 | 0.999 | 0.066 | 46.3 | 17 |
| μmoles/cm² SO₃H) | | | | |
| V - Kynar Bonded (1.1 μmoles/ | | | | |
| cm² SO₃H) | | | | |

*IS = Impedance Spectroscopy

MEA V, with the Kynar bonded catalyst layer, displayed good performance at low current densities but poor performance at high current densities. Flooding was prevalent in this cathode. The regression parameters are those derived when the best performance was observed, as the cathode was going from a transition from being flooded to being dehydrated (effected by introducing dry feed gas into the a flooded system). Under these selected conditions, the Eland b values for the Kynar bonded MEA V are quite similar to those for MEA II while its R value is much larger. Thus at low current densities (where the effect of R is small) the two MEA's have comparable performance but not at the larger current densities. On the other hand, the resistances of MEA II and MEA V, as measured by impedance spectroscopy) are comparable. This suggests that the poor catalyst performance of MEA V at high current densities is the result of flooding which causes an increase in mass transfer resistance which, in turn, causes the resistance value derived by regression to become large.

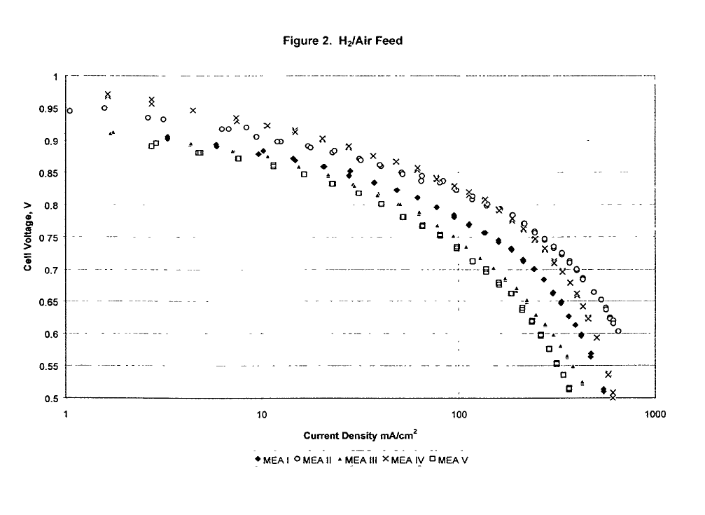

The experimental points obtained with air as the oxidant for the same set of MEA's are presented in FIG. 2. They show the same trends as those obtained with oxygen as the oxidant.

Accessible Platinum Surface Area

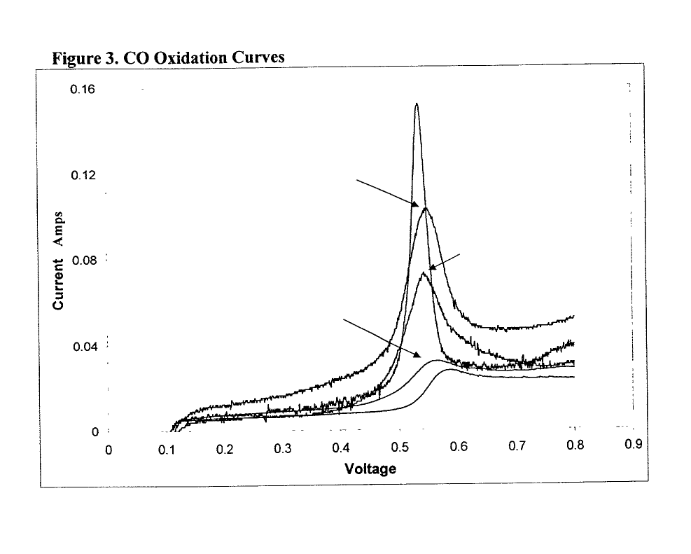

The five MEAs's characterized above were prepared from the same lot of catalyst. Accordingly, the platinum particle size and, hence, platinum specific surface area for the 5 MEA's are identical. The accessible platinum surface area (that is, the surface area of platinum particles which are in ionic contact with the membrane) in the catalyst layers in the five MEA's was determined by means of cyclic voltammetry. For these purposes, oxygen was flushed from the fuel cell cathode flow field using a large excess of nitrogen. Thereafter, a 10 minute feed of 10% CO in N₂ was passed into the catalyst layer to cover the platinum surface with CO. The cell was then flushed with nitrogen to remove unadsorbed CO. Finally, the cathode was subjected to a voltage that was increased from 0.1 to 0.8 volts at 2 mV/s to oxidize the adsorbed CO. The curves obtained are depicted in FIG. 3. The accessible surface areas were obtained by integration of the CO oxidation curves and the results obtained are summarized in Table 2.

TABLE 2
Accessible Platinum Areas as Measured by Cyclic Voltammetry

| MEA | Accessible Platinum Surface Area, m²/g |
|---|---|
| I - No Treatment (0 μmoles/cm² | 10 |
| SO₃H) | |
| II - Nafion (0.45 μmole/cm² | 77 |
| SO₃H) | |
| III - Aqueous Treatment (˜0.1 | 14 |
| μmoles/cm² SO₃H) | 62 |
| IV - Aqueous/IPA Treatment | 85 |
| (>0.2 μmoles/cm² SO₃H) | |
| V - Kynar Bonded 1.1 μmoles/ | |
| cm² SO₃H) | |

The results in the table demonstrate that in the absence of proton conducting groups in the catalyst layer, as in the case of MEA I, very little of the platinum, about 10 m²/g, is accessible. Addition of Nafion to the catalyst layer, MEA II, increases the accessible area to 77 m²/g. MEA V having the largest —SO₃H population exhibits the highest, 85 m²/g, accessible catalyst area, demonstrating that attachment of C₆H₄SO₃H groups to the supported catalyst provides effective ionic conductivity. As already noted, flooding caused its poor performance in the fuel application. MEA IV, having more than 0.2 μmoles/cm² of attached C₆H₄SO₃H groups (but less than MEA V) and exhibiting a comparable fuel cell performance to MEA II, has a somewhat reduced, 62 m²/g, accessible platinum area. This may be due to the presence of fewer SO₃H groups than for MEA II. The accessible Pt surface in the case of MEA III is not much larger than that for MEA I suggesting that the level of proton conducting groups, about 0.1 μmoles/cm², are insufficient to allow full Pt accessibility.

Carbon Black Morphology and Treatment Levels

VULCAN XC72, BLACK PEARLS 2000 and CSX 619 were treated to attach various groups to their surfaces. The BET surface areas, the micropore-free surface areas (t-areas), the t-area:BET surface area ratios and micropore volumes of the carbon blacks before and after attachment of the various groups were determined. The results obtained, the groups attached, and their levels are presented in Table 3.

TABLE 3
Effect Of Treatments on Surface Area And Micropore Volumes

| | | | | | | t-area: |
|---|---|---|---|---|---|---|
| Carbon | Group | Level | BET Area | t-Area | Micropore | BET area |
| Black | Attached | Weight % | M²/g | m²/g | Vol., cc/g | ratio |
| Vulcan | None | 0 | 233.4 | 143.7 | 0.040 | 0.62 |
| XC72 | —C₆H₄SO₃H | 4 | 182.9 | 126 | 0.023 | 0.69 |
| | —C₆H₄SO₃H | 10.7 | 89.6 | 64 | 0.011 | 0.71 |
| | —[C₆H₄NC₅H₄] | 5.9 | 143.9 | 122 | 0.009 | 0.85 |
| | NO₃ | | | | | |
| CSX | None | 0 | 538 | 412 | 0.07 | 0.77 |
| 619 | —C₆H₄SO₃Na | 10 | 367 | 364 | 0.002 | 0.99 |
| BP 2000 | None | 0 | 1446 | 660 | 0.347 | 0.35 |
| | —C₆H₄SO₃H | 26.7 | 316 | 206 | 0.050 | 0.65 |

The results in the table demonstrate that the untreated carbon blacks have relatively large micropore volumes. In general, the micropore volumes of furnace blacks increase with increasing surface areas. For many furnace blacks, the t-area:BET area ratios decrease as surface area is increased, demonstrating that micropores make an increasing contribution to the total surface area. Since diffusion rates in micropores are slow, the accessibility of platinum deposited in such pores will be mass transfer limited. As already mentioned, at a constant platinum deposition level, platinum particle size decreases as support surface area increases. Thus, there is a tradeoff between the benefits of reduced catalyst particle size and reduced catalyst accessibility, making catalyst activity relatively insensitive to support surface area. In the case of CSX 619, however, its t-area:BET area ratio is much larger than those for either VULCAN XC72 or BP 2000 while its t-area lies between them. These features suggest that the tradeoff between decreased catalyst particle size and reduced catalyst accessibility would be improved by using CSX 619 carbon black as the catalyst support. Moreover, since its DBP value (1.0 cc/g) is considerably smaller than those for VULCAN XC72 (1.78 cc/g) or BP 2000 (3.3 cc/g), its use will result in much thinner catalyst layers.

The effect of attachment of surface groups is to reduce BET areas, t-areas and micropore volumes. The extent of these reductions, as shown by the data for VULCAN XC72, increase with attachment level. In all cases, the treatments, regardless of level employed, increases the t-area:BET area ratio. Thus, deposition of the catalyst on a treated support should result in a further enhancement in catalyst accessibility.

Treatment of Acetylene Black with PTFE

As noted previously, the PTFE in the catalyst layer provides hydrophobic pores, assisting mass transfer of gas to the catalyst. Its presence, however, at least partially covers the catalyst. Mass transfer rates to areas where the catalyst surface is covered by PTFE is impeded because it takes place only after dissolution of the gas in the PTFE followed by its diffusion to the catalyst surface. Experiments were conducted to determine the effect of treatment with PTFE on support surface area and the fraction of the area not covered by PTFE. Since a diazonium salt does not react with PTFE, the fraction of the carbon surface not covered by PTFE was evaluated by diazotizing an acetylene black before and after treatment with PTFE with the diazonium salt of sulfanilic acid. The ratio of the amount of sulfur attached to the surface of the black before and after treating with PTFE gives a reliable measure of the fraction of the surface not covered by PTFE.

In the experimental work, 0.833 g of Teflon PTFE 30 dispersion was added to 4.5 g of AB 100 acetylene black (Chevron) in 400 ml of water. The slurry was sonified for 20 minutes with a probe type sonifier. Thereafter, its pH was reduced to 3.0 by addition of dilute HCl. The dispersion was then filtered and the filter cake was washed with a large volume of water to ensure it was free of chloride ions. The cake was dried at 100° C. and then sintered for one hour at 360° C. under nitrogen to yield a product, sample 7420-80D, containing 10 weight % PTFE. A similar treatment was run to form a product, sample 7420-80F, containing 30 weight % PTFE.

Part of each of the samples, containing 10 and 30 weight % PTFE, was treated with an equal weight of the diazonium salt of sulfanilic acid in water containing 30 weight % isopropanol at 70° C. Since the amounts of diazonium salt and sample employed were comparable, the amount of treating agent used substantially exceeded that required for full surface attachment. The products were isolated by filtration, washed with copious amounts of water and methanol to remove unattached material and dried. The surface areas and sulfur contents of the samples before and after the diazonium treatment were determined. The difference in sulfur levels before and after treatment gives the level of attached sulfur. The sulfur content of the diazotized PTFE-free acetylene black was not measured but experience indicates that a maximum of 4.5 μmoles/m of —C₆H₄SO₃Na can be attached to the surface of carbon. Based on this figure, the diazotized acetylene black will contain a maximum of 11100 ppm sulfur. The ratio of sulfur concentrations introduced by the dizaotization treatment in the PTFE treated black, on a per unit weight of acetylene black basis, to that in the PTFE-free black was determined. The value of this ratio provides a measure of the fraction of the carbon surface to which attachment was possible and, hence, to the fraction of the surface not covered by PTFE. The results obtained are summarized in Table 4.

The surface area data in the table show that the PTFE treatment results in a rapid diminution in surface area. The sulfur numbers demonstrate that the PTFE covers a substantial portion of the carbon surface, being 68 and 85% at the 10 and 30% PTFE treatment levels, respectively. Thus, although PTFE provides hydrophobicity, these numbers show that it does block access to the catalyst surface.

TABLE 4
Effect of Sintered PTFE

| | Diazonium | | | | |
|---|---|---|---|---|---|
| PTFE | Salt | BET Area | t-Area | Sulfur | *Surface |
| Weight % | Treated | m²/g | m²/g | ppm | Fraction |
| 0 | No | 83.2 | 81.6 | 69 | 1 |
| | Yes | **ND | ND | 11100 | |
| 10 | No | 43.7 | 43.7 | 58 | 0.32 |
| | Yes | 48.4 | 44.7 | 3855 | |
| 30 | No | 30.2 | 30.6 | 41 | 0.15 |
| | Yes | 33.9 | 31.2 | 1254 | |

*Fraction of surface acetylene black, on a per unit weight basis (i.e., after acetylene black not covered by PTFE
**ND = Not Determined

Hydrophobic Carbon Blacks

Hydrophobic carbon blacks were made by the following procedures:

1) VXC 72 carbon black samples were treated with progressively increasing amounts of the diazonium salt of 3-trifluoromethyl aniline using the procedures in U.S. Pat. No. 5,851,280. The sample labels and the mmoles of attached triflourophenyl were:

Sample 7591-76-1, with 0.078 mmoles -C₆H₄CF₃ attached.

Sample 7591-76-2, with 0.17 mmoles -C₆H₄CF₃ attached.

Sample 7591-76-3, with 0.37 mmoles -C₆H₄CF₃ attached.

Sample 7591-76-4, with 0.52 mmoles - C₆H₄CF₃ attached.

2) Solutions containing 0.864 kg of the Zonyl FSD cationic surfactant solution (30 weight % surfactant) in 4.32 kg of water was prepared. The resulting solution contained 0.432 moles of surfactant. It was added over 10 minutes to 20 kg of a diafiltered, stirred, 10 weight % aqueous dispersion of BP 700 carbon black having 0.5 mmoles/g product of attached —C₆H₄SO₃Na groups. Stirring was continued for an additional 60 minutes after which the flocculated product was isolated by filtration and then washed until it was chloride-free and finally dried at about 100° C. The product was labeled PFX 5520. The molar ratio of Zonyl FSD to attached —C₆H₄SO₃Na groups in the PFX 5520 product was 0.43:1.

Zonyl FSD, 10 g, was diluted with 50 g of water. The resulting solution contained 5.0 mmoles of surfactant. A 10 g sample of diafiltered VXC 72 with 0.68 mmoles/g of attached —C₆H₄SO₃H groups was dispersed in 100 cc of an aqueous medium containing 40 weight % isopropanol. The surfactant solution was added over 10 minutes to the stirred dispersion. Stirring was continued for an additional 60 minutes after which the resultant product was isolated by filtration, washed until it was free of chloride ions and dried at 100° C. The product was labeled XXX.

3) Poly(hexafluoropropylene oxide -co- difluoromethylene oxide)alcohol was reacted with p-nitrophenyl isocyanate in dry tetrahydrofuran. The crude product was hydrogenated in ethanol in the presence of a catalyst (5% palladium on activated carbon). Separation of the catalyst was accomplished by filtration to produce a perfluoroether-aniline having a nominal molecular weight of about 850 and with the structure:

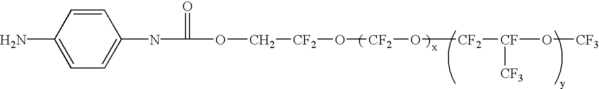

The aniline, 6 g, was dissolved in 18 g of ethanol for its subsequent use for attachment by the diazotization reaction. A pasty slurry consisting of 10 g of BP 700 carbon black in 24 g of ethanol was formed. To the stirred slurry maintained at 50° C. the following reagents were sequentially added: 13 g of 70 weight % HNO₃ diluted with 32.4 g water, the aniline solution and 5 g NaNO₂ dissolved in 20 g of water. The NaNO₂ solution was added over a 30 minute time period. The reaction mix was stirred for an additional 30 minutes after which the product (PFX 5830) was filtered off, washed with ethanol and finally dried.

3) An alcohol terminated polydimethyl siloxane (PDMS) with the structure

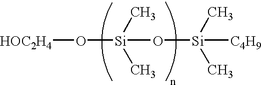

and having a molecular weight of about 1000 (Gelest, Inc.) was reacted with p-nitrophenyl isocyanate in dry tetrahydrofuran. The resulting product was hydrogenated in ethanol using a 5% palladium on activated carbon catalyst. The catalyst was removed by filtration to yield a solution of a PDMS containing aniline. The aniline, 7.2 g dissolved in 18 g of ethanol was added to 10 g of BP 700 carbon black slurried in 24 g of ethanol. Diazotization was accomplished using the same procedure as that of the previous example, yielding the hydrophobic product PFX 5840

Knowledge of the extent of hydrophobicity generated by the various treatments was obtained by determining the volume fraction of methanol in a methanol/water solution required to just wet the sample. This was evaluated by shaking a 0.1 g sample of the various materials in aqueous media containing progressively larger volume percentages of methanol.

Catalyst Preparation

A series of supported 20% Pt catalysts were prepared using the procedure of Comparative Example A of Hards et al. (European Patent Application 0 512 713 μl). The supports employed, the groups (if any) attached to their surfaces prior to deposition of Pt and their levels are shown in Table 5. The support, 0.8 g, together with 125 ml of water was placed in a 500 ml three necked flask fitted with a condenser and a stirrer. The contents of the flask were heated to and maintained at 60° C. Sodium bicarbonate, 0.470 g in 3 ml of water was added to the slurry which was stirred for 5 minutes and then heated to and maintained at 100° C. for 30 minutes. An 8% chloroplatinic acid solution, 5.26 ml (containing about 0.20 g platinum), was added over about 12 minutes to the slurry which was then boiled and stirred under reflux for two hours. The slurry was cooled to 90° C. and 5.56 ml of a 1% formaldeyde solution was added. The slurry was stirred and boiled for an additional hour. Three procedures were then used to isolate the products. The untreated, conventional carbon blacks were isolated by filtration followed by washing until the filtrates were chloride-free. The cakes were dried at 105° C. Sample 6386-xxx (based on the use of CSX 619 with 0.4 mmoles of —C₆H₄SO₃Na groups) was washed by filtration with 1 M sulfuric acid (to ensure that any —C₆H₄SO₃Na present is converted to —C₆H₄SO₃H) and then with water until the filtrate was sulfate and chloride-free. The cake was dried at 105° C. The remaining samples formed relatively stable dispersions. In these cases, contaminants were removed by contacting the dispersions with a large excess of a mixture of cation and anion exchange resins which were in their H⁺ and OH⁻ forms. The resins were separated from the dispersions by screening. Thereafter the dispersions were dried overnight at 60° C. to give the solid catalysts.

TABLE 5
Catalyst Substrates

| | | | Level, mmoles/g |
|---|---|---|---|
| Label | Black Grade | Group Attached | (initial) |
| 6386- | VXC 72 | None | 0 |
| | | —C₆H₄SO₃H | 0.13 |
| | | —C₆H₄SO₃H | 0.24 |
| | | —C₆H₄SO₃H | 0.31 |
| | | —C₆H₄SO₃H | 0.68 |
| | CSX 619 | None | 0 |
| | | —C₆H₄SO₃Na | 0.4 |
| 6386- | BP 2000 | None | 0 |
| | | —C₆H₄SO₃H | 1.33 |

Catalyst Preparation By Ion Exchange

To 0.5 g samples of BP 2000 carbon black with 1.33 mmoles/g of attached C₆H₄SO₃H groups varying aliquots of a 0.0774 molar [Pt(NH₃)₄]Cl₂ solution (15.1 mg Pt/ml) were added. The resulting dispersions were shaken for two hours at ambient temperatures, filtered and the Pt concentration in the filtrate determined by ICP (Inductively Coupled Plasma Spectroscopy). The volumes of solution employed and the fraction of the [Pt(NH₃)₄]²⁺ complex removed from solution are summarized in Table 6.

TABLE 6
Ion Exchange With Cationic Pt(II) Complex

| | | Filtrate Pt | |
|---|---|---|---|
| Sample | Aliquot Volume | Concentration | Fraction Pt |
| No. | Ml | mg/ml | Exchanged |
| 6386-43-2 | 8 | 5.7 | 0.62 |
| 6386-43-3 | 12 | 8.3 | 0.45 |
| 6386-43-4 | 15 | 9.8 | 0.35 |

The results in the table show that substantial fractions of Pt are removed from solution by ion exchange, presumably in the form of [Pt(NH₃)₄]²⁺ counterions to the attached —C₆H₄SO₃⁻ groups. Reduction of the [Pt(NH₃)₄]²⁺ counterions by a reducing agent, such as with a solution of NaBH₄, yields a finely divided Pt. After reduction, the attached —C₆H₄SO₃⁻ groups can have H⁺ counterions. This can be accomplished either by washing the product with acid followed by water or by passage of the dispersion through a bed containing a cation exchange resins in its H⁺ form.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A fuel cell comprising a gas diffusion electrode, a gas diffusion counter-electrode, a solid electrolyte membrane located between the electrode and counter-electrode, wherein the electrode or the counter-electrode or both comprise at least one modified carbon product, wherein said modified carbon product comprises a carbon product having attached at least one organic group.

2. The fuel cell of claim 1, wherein said solid electrolyte membrane comprises at least one modified carbon product, wherein said modified carbon product comprises a carbon product having attached at least one organic group.

3. The fuel cell of claim 1, wherein said gas diffusion electrode and gas diffusion counter-electrode each comprise a blocking layer and an active layer.

4. The fuel cell of claim 3, wherein said active layer or said blocking layer or both comprise at least one modified carbon product, wherein said modified carbon product comprises a carbon product having attached at least one organic group.

5. The fuel cell of claim 3, wherein said active layer has a thickness of less than about 10 microns.

6. The fuel cell of claim 3, wherein said active layer comprises at least one modified carbon product, wherein said modified carbon product comprises a carbon product having attached at least one organic group and a metal catalyst.

7. The fuel cell of claim 3, wherein said active layer has no fluoropolymer binder present.

8. The fuel cell of claim 1 wherein said solid electrolyte membrane comprises polytetrafluoroethylene.

9. A fuel cell comprising a gas diffusion electrode, a gas diffusion counter-electrode, a solid electrolyte membrane located between the electrode and counter-electrode, wherein said solid electrolyte membrane comprises at least one modified carbon product, wherein said modified carbon product comprises a carbon product having attached at least one organic group.

10. The fuel cell of claim 1, wherein said organic group is —C₆H₄SO₃⁻.

11. A method to reduce the thickness of a solid electrolyte membrane comprising forming said electrolyte membrane with a modified carbon product, wherein said modified carbon product comprises a carbon product having attached at least one organic group.

12. A method for increasing catalyst accessibility in an electrode comprising forming an active layer with a modified carbon product in the absence of a fluoropolymer binder, wherein said modified carbon product comprises a carbon product having attached at least one organic group.

13. The method of claim 12, further comprising the deposition of a catalytic material on said modified carbon product.

14. The fuel cell of claim 1, wherein said organic group is a proton conducting group, an electron conducting group, or both.

15. The method of claim 11, wherein said organic group is a proton conducting group, an electron conducting group, or both.

16. The method of claim 12, wherein said organic group is a proton conducting group, an electron conducting group, or both.
